(19) United States
(12) Patent Application Publication
(10) Pub. No.: US 2013/0089305 A1
(43) Pub. Date: Apr. 11, 2013

(54) GENERATING PERSONALIZED DYNAMIC VIDEOS

(71) Applicants: Oren HARNEVO, Brooklyn, NY (US); Gal BARNEA, Tel-Aviv (IL)

(72) Inventors: Oren HARNEVO, Brooklyn, NY (US); Gal BARNEA, Tel-Aviv (IL)

(73) Assignee: EYEVIEW INC., Tel-Aviv (IL)

(21) Appl. No.: 13/367,241

(22) Filed: Feb. 6, 2012

Related U.S. Application Data
(60) Provisional application No. 61/543,324, filed on Oct. 5, 2011.

(51) Int. Cl. G11B 27/02

(52) U.S. Cl. 386/285; 386/278; 386/E05.028

(57) ABSTRACT

Embodiments of the present invention relate to a method for obtaining through one and/or more feed generators parameters of a digital video, such that the video is adapted to be provided to users of a network. The method further includes modifying by one and/or more software generators one or more of the obtained parameters, such that the modification is based on information relating to segments of the users of the network. In addition, the method includes creating by one and/or more rendering engines, based on the modification, a plurality of versions of the digital video, such that each one of the plurality of versions comprises a digital video adapted to appeal to at least one of the segments of the users of the network.

### BACKGROUND

1. Technical Field

The present invention relates to a method for generating personalized digital videos over websites delivering advertisement content.

2. Discussion of the Related Art

Wide spread digital mediums, such as the Internet; have provided digital providers an almost unlimited platform for reaching and distributing content to almost any region or any country in the world. Indeed, advertisers and vendors currently user the World Wide Web as an extensive marketing tool for disseminating information relating their products and services in a wide variety of digital forms and venues. One such venue that has become quite popular are digital videos, such as those that are intermittently downloaded during regularly watched web video including a wide variety of content, some of which may include advertizing ads and commercials appearing before, between or after the webpage and/or video the viewer is watching. Normally displayed on a computer screen, handheld device, a smart phone, or the like for a few minutes or so, a user usually views such ads as clips illustrating moving images, objects, actors and all elements typically involved in a movie video adapted to promote, enhance, or otherwise convey marketing and related information.

While technological advancement have been made in developing and distributing marketing videos to many users, such videos will always remain generic in nature and those may not provide specific content with which certain users located in certain region or users belonging to certain segments, i.e., genders, cultures can personally associate. For example, a commercial video adapted to promote items, such as an automobiles, household products, clothes, beverages and the like, may inherently include scenery, sounds, or other type of features to which certain users may not necessarily relate or have any personal affiliation. More specifically, as part of an advertisement, vendors can mass distribute commercial a video to a variety of locales, behavioral or demographic information dispersed over area such that those sceneries, sounds and images (i.e., weather condition, certain population segments) may not be part of the everyday life or experience of the viewer because watching such a videos. Thus, specific viewers may not connect on a personal level with the provided wide spread and generic commercial content. Consequently, vendors may miss out on promoting their products and/or services to a wide range of audience as would be desired for by any vendor for achieving a robust marketing effort.

### BRIEF SUMMARY

Exemplary embodiments of the present technique disclose a method and systems for personalizing video data generally provided in a digital medium like Internet and network connected devices. Accordingly, the disclosed systems are adapted to retrieve original feeds and ad information, such as webpages, movie ads, and so forth, for altering such information, in accordance with personalized data, thereby achieving custom fitted videos intended for various users located in different regions and places. In other aspects of the present technique, the disclosed videos can be custom fitted to appeal to certain users based on specific behavioral, demographic, and/or gender-based attributes with certain users may be associated. Accordingly, such data may be provided by vendors or third party entities, or other entities wishing to promote or offer various products. In other aspects according to the present technique, videos can be personalized in accordance to certain object criteria, such as adapted to be shown on certain times of a day, days of a week, or those shown in certain time of a year such holidays and/or special commemorative occasions to which certain individuals accessing the network can relate.

While the present technique may alter an original video ad to create multiple ad versions targeting and/or appealing to the various dispersed users, the present technique is, nevertheless, adapted to preserve the substantive content and the overall uniformity conveyed by the different ads ultimately created. In addition, the present technique provides the multiple ad versions of the video while achieving broadcast quality of those multiple version equivalent, if not better, to the broadcast quality of the originally obtained ad video. Hence, in so doing, the present technique provides each of the multiple versions of videos in a quality that appears and, indeed, matches an original video, so that certain users watching a video tailored in accordance with their personal and/or other preferences may perceive the video in broadcast quality an originally obtained and distributed video. Hence, the term broadcast quality, as used herein, refers to a quality of video forming the multiple versions of videos adapted to appeal to certain users to match the quality of an otherwise original video provided to an entire network.

In so doing, the present technique makes use of certain software and/or hardware elements for defining dynamical templates of an advertisement to accommodate personalized user preferences, such certain local lifestyles, local weather conditions, gender, demographic make up, times of day, week, year, holidays, local prices and personalized visual, audible and/or textual features. Once the particular definitions are implemented for each template, the present technique renders multiple versions of the movie or commercials advertisement in accordance with the above preference. Thereafter, the disclosed systems provide an output, whereby the multiple movie versions distributed to various locales across the network. Ultimately, each of the different network locales is adapted to receive personalized advertisements having content similar to the content of the original ad. However, such a personalized may include various scenery, images, sounds, objects, texts and so forth, tailored to be personalized and specific to various users, for example, such as those located specific regions or those having a personal preference, relation, or liking, respectively, to certain features the ad may include. Thus, in accordance with the present technique, advertisers are better adapted to reach and target a consumer audiences for promoting information associated with their products and/or services.

Other aspects of the invention may include a system arranged to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a block diagram a digital item, in accordance with an exemplary embodiment of the present technique.

FIG. 2 is a depiction of a video scene, in accordance with and exemplary embodiment of the present technique.

FIG. 3 is a depiction of another video scene, in accordance with an exemplary embodiment of the present technique.

FIG. 4A is a block diagram of a system for providing personalized video over a network, in accordance with an embodiment of the present technique.

FIG. 4B illustrates a network utilized for providing personalized video, in accordance with an embodiment of the present technique.

FIG. 5 is a block diagram describing a process, in accordance with an embodiment of the present technique.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

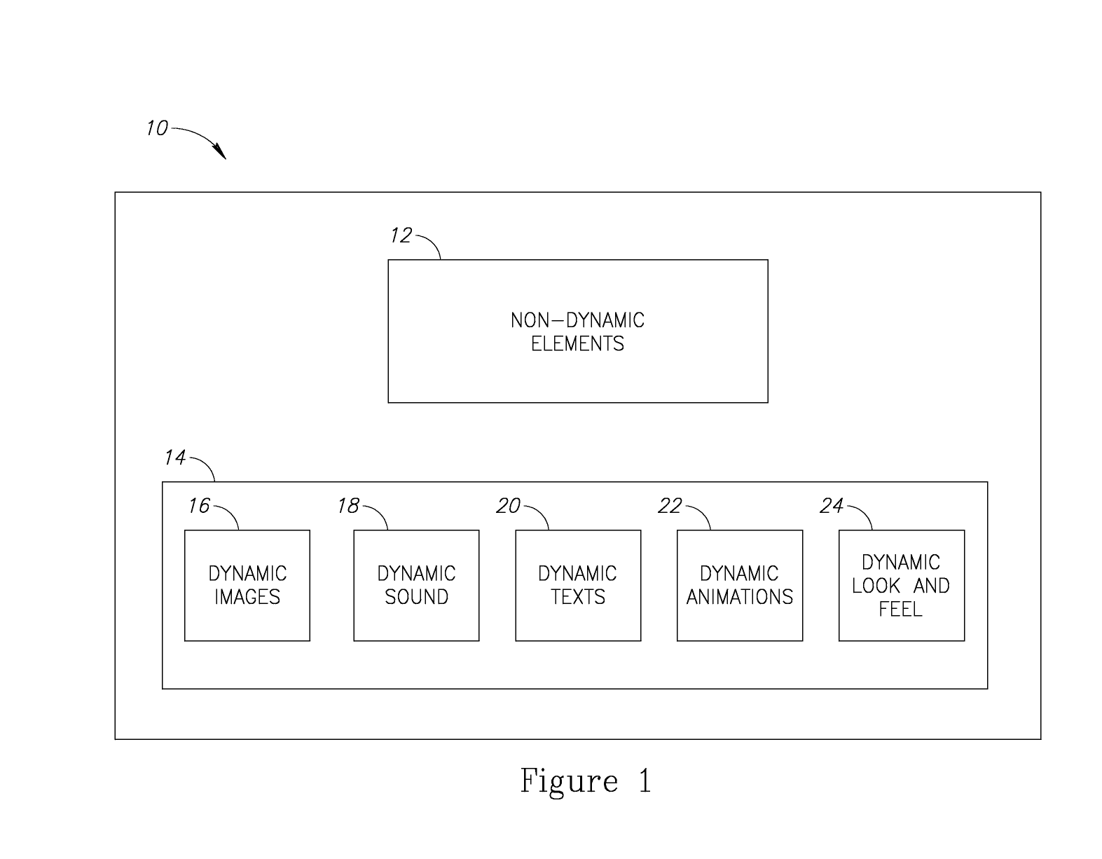

Referring now to the figures, particularly, FIG. 1 is a block diagram a digital item 10, in accordance with an exemplary embodiment of the present technique. The digital item/template 10 may generally be part of a structured digital object, a form, or a combination of resources such as videos, audio tracks, images; or metadata, which may further include items such as descriptors and identifiers; and structures for describing the relationships between the resources the digital item/object, may include.

More specifically and in accordance with an embodiment of the present technique, the digital item 10 forms a digital movie and/or images part of an advertisement, commercial and/or other promotional material. Accordingly, those skilled in the art will appreciate that the depiction shown in FIG. 1 is more of a representation of digital components from which such digital items are formed and therefore, the depiction of such elements are exemplary for illustration purposes included herein to provide a general understating of the present technique.

Thus, the digital item 10 may form a digital movie part of an advertisement or commercial adapted to be displayed, viewed and/or heard on a computer, such as a home, office or any other type computing device, i.e., mobile device or a handheld device etc. Hence, movie advertisements formed by the digital item 10 may be provided over the Internet so that those may be downloadable by the users at various locales, regions and countries at their time of choosing or at designated times, as may be determined by a vendor, advertiser and/or other enterprises wishing to promote and/or disseminate information to the general public. Accordingly, such movie commercials may be made up of data forming substantive information and various contents that can be typically played on an Internet digital player, spanning a time duration that could last seconds, minutes or longer, depending on choice of the various providers making use digital items, such as the item 10.

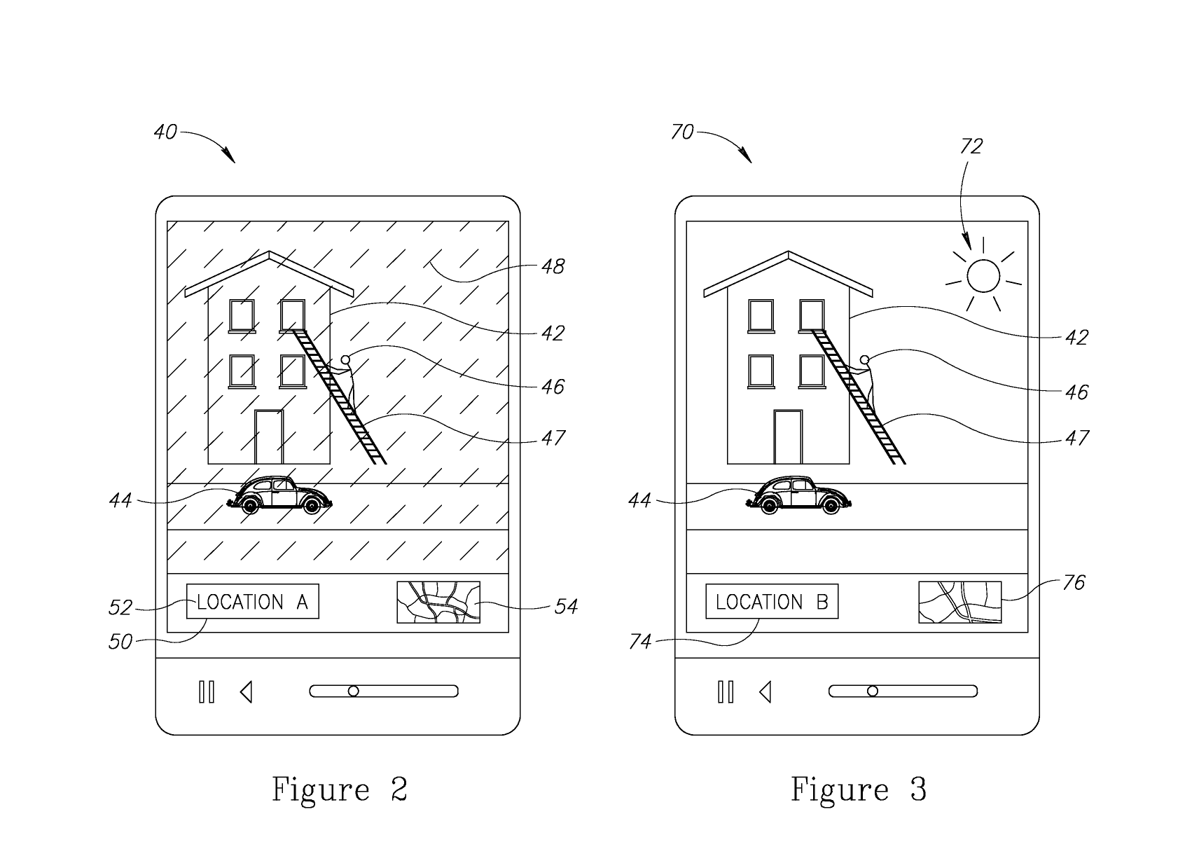

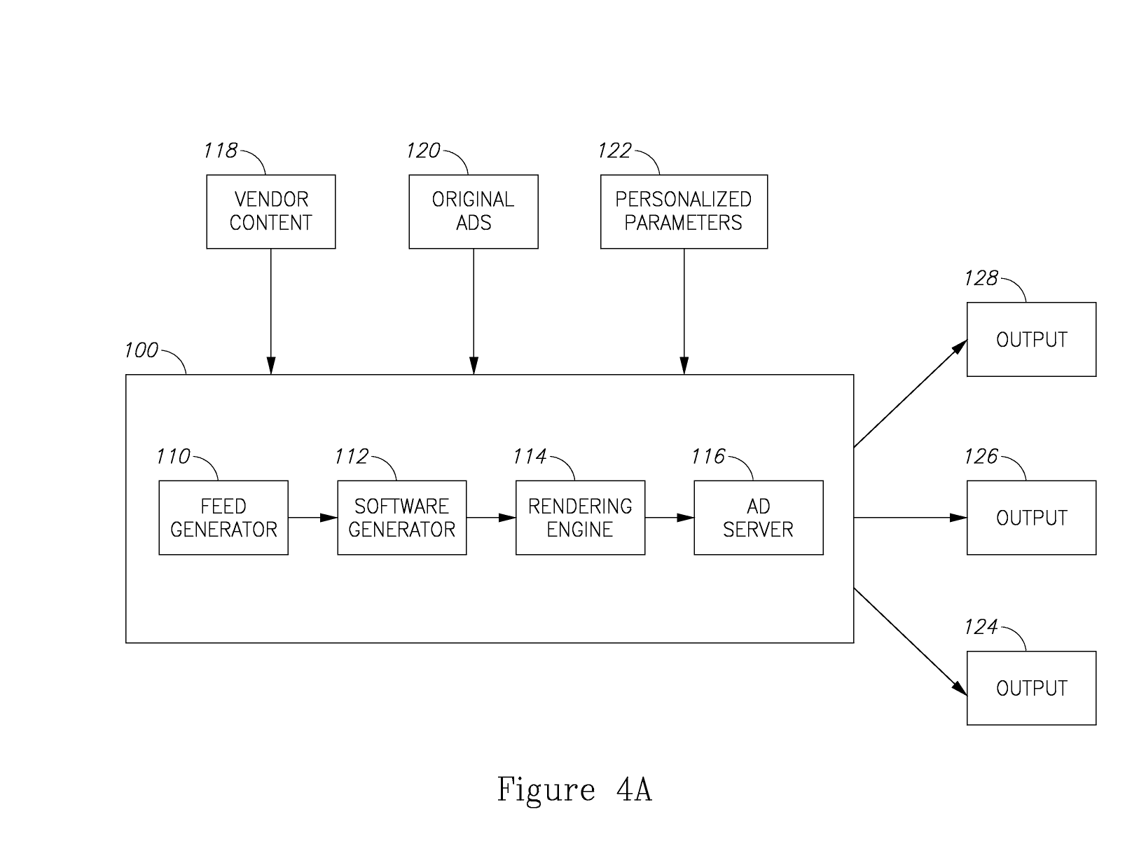

As further illustrated by FIG. 1, the digital item 10 is made up of non-dynamical elements 12, as well as dynamical elements 14, including dynamic images 16, dynamic sounds 18 and dynamic texts 20. The dynamic elements 14 is further made up of dynamic animations elements 22 and dynamic look and feel elements 24. The non-dynamical elements/data 12 of the digital item 12 are elements that are usually static and are otherwise not personalized to the specific user to which the commercial formed by the item 10 is intended. In other words, the non-dynamical elements/data 12 form those features of an advertisement that would be provided to all users viewing the advertisement, regardless of the region in which the various users are located or their respective personalized preferences. Thus, non-dynamical elements 12 may be associated with certain objects, features, or other attributes (see below FIGS. 2 and 3) shown in each and every version of an advertisement originating from the item 10, as provided to the user. For example, in one embodiment the elements 12 may form an image or movie of person whose depiction overtime would be identical regardless of where and how the commercial is shown. By further example, the elements 12 may form portions of landscape, trees, grass, buildings and/or other moving or static elements that would be displayed identically in all personalized video commercials.

By contrast, dynamical elements 14 are those elements within the commercial or ad intended to be varied and/or modified in accordance with preferences tailored for specific users, for example, located in various regions. Thus, dynamic images element 16 may form certain images or portions thereof of a commercial clip that could be specifically custom made to the user viewing the commercial. For example, the element 16 may form background sceneries, conditions or views, such as oceans, trees, roads, bridges and other scenery typifying the general location where certain users may reside, work, or those locations certain users may some relation or affiliation. By further example, element 16 may emulate weather conditions i.e., sunshine, rain, snow, fall, winter and so forth, normally typifying conditions at a locale of a respective consumer who is viewing the advertisement. Hence, the dynamic image elements 16 may emulate various lighting, brightness, shading, and other visual effects and conditions and features to fit various settings in various regions. Still by further example, dynamical elements 16-24 may include features specific to a particular gender, that is, the elements 14 may incorporate in an otherwise generic videos features adapted to appeal to a specific gender in which certain attributes of the video could accentuate certain features to which the targeted gender can relate. For example, a video displaying an automobile commercial can be personalized to appeal to women by using the dynamic images 16, and or animation element 22 to form an automobile having color usually likeable to women, such as pink, red, etc. Hence, while the aforementioned automobile commercial may originally be created and widely distributed as a generic advertisement having a generic automobile color, i.e., a color not necessarily adapted to target an audience segment, the present technique may create multiple versions of the advertisement, whereby each version is adapted to accentuate a particular feature bound to appeal to certain users who may find such features interesting or at least worth noting.

Similarly, dynamic sounds element 18 forms an audible portion of the digital item 10 which can be changed and/or tailored in accordance to consumer location and/or other preferences. Thus, the elements 18 can form part of an audible portion adapted for specifying specific locations, such as streets, buildings, parks and/or other landmarks that could be of interest and are specific to the user's locations and other preferences, such various languages, gender voice, accents, dialects. Thus, for example, dynamical sounds element 18 can be used to alter a certain dialect or an accent of a speaker of generic-made commercial to include a dialect appealing to certain population groups. For example, a commercial, originally having an actor/speaker utilizing a particular accent (i.e., Anglo-American) can be personalized to show that same speaker talk in a different accent, i.e., such that shared by Spanish-American, so as to provide such a group similar informational content, yet more personalized and appealing to that group.

In addition, dynamic texts element 20 provides a portion of digital item 10 having textual portions which, too, can be changed to fit the location and other attributes with which the viewer is associated. Hence, the dynamic texts element can form any readable or otherwise viewable contexts such as titles and subtitles, product names, service names, street names, maps, satellite photography and the like. Thus, the digital item 10 can be part of a commercial ad advertized, for example, by a chain store or a franchise having multiple stores dispersed in different locations across a country or region, whereby the dynamic text elements 20 are adapted to display, for instance, a general map showing the store location in relation to where the ad or movie commercial is shown. For example, a viewer in Los Angeles, Calif. will view the commercial in which the element 20 is adapted to display a map of the store closest to the viewer located in the LA area. Similarly, a viewer in Miami, Fla. will be able to see the same commercial while being provided with substantive content similar to that of the ad shown in the LA area, however, the commercial provided to the viewer in the Miami area will include a map showing the user where the closes store in that area is located.

In so doing, the present technique contemplates using the digital item/template 10, particularly, the dynamic elements 14 to generate multiple versions of commercial videos, each having similar informational content, yet, each generated to custom fit user(s) preferences, such as user locations throughout a given region.

FIGS. 2 and 3 are depictions of video scenes, in accordance with and exemplary embodiment of the present technique. Hence, for example, FIG. 2 depicts a commercial scene 40, such as one provided by a vendor or chain store, for advertizing and promoting various products and/or services. As illustrated, the scene 40 includes various items and objects, such as a house 42, car 44, person 46 and ladder 47. Accordingly, the commercial seen 40 may be adapted to promote products, such roofing of the house 42, ladders (e.g., ladder 47), and/or services (e.g., roofing, landscape and other services). Further, the scene 40 also includes a background 48, for example, indicative of certain weather winter-like condition, i.e. rain, storms and so forth. As further shown, at the bottom of scene 40, the illustrated embodiment further includes a portion 50, including a text box 52 and a map portion 54. Accordingly, text box 52 and map portion 54 are adapted to provide a viewer with location and other details regarding specific stores located within the vicinity of the user. Hence, the scene 40 can be generated and custom fitted to include certain information, such as hours of operation, special products, special sales and discounts and other types of promotional material, all specific to the region in which the commercial movie is displayed, as well as specific to other personalized preferences that would enable vendors to appeal to certain segments of users having access to a network on which personalized videos are accessible.

In addition, in the illustrated embodiment of scene 40, the background 48 can be chosen to include weather-like conditions indicative of the conditions observed and experienced in accordance with the where the specific store is advertized. Thus, the winter-like conditions 48 of scene 40 can be tailored to fit places such as those located, for example, in the northeastern portions of the United States, where similar conditions may apply and where a consumer may be experiencing similar whether conditions. Hence, in providing consumers with video contents tailored to consumers' settings, vendors and/or advertisers can target and better appeal to consumer's preferences and/or locale conditions that are specific to where such consumers are located.

By further example, FIG. 3 shows a scene 70 that is almost identical to the scene 40 of FIG. 2 with exceptions of background 72, text box 74, and map portion 76, all providing similar content and information, yet, specific to a location different from that shown in FIG. 2. Accordingly, in the illustrated embodiment of FIG. 3, background 72 illustrates a clear, sunny-like day indicative of weather conditions that could otherwise present, for example, in the southwestern portions of the United States. Thus, while the scene 70 may be part of a commercial identical to the one provided by the scene 40, the scene 70 may include content and other information adapted for appealing to consumers located in the aforementioned part of the U.S., and where corresponding vendor stores and locations are located. Thus, text box 74 and map portion 76 correspondingly provide the consumer located in that part of the country information pertaining to location, store hours, products, special sales and other related material specific to where the consumer is located.

Still by further example, a chain store promoting certain home and related products can use specially tailored made commercials, such as the scene 40, for advertizing certain winter tools, such as snow plows, shovels and other winter items to those populations located in regions where the scene 40 experiencing a winter like-setting. Thus, to the extent the user of scene 70 is provided with substantive information similar to that provided in scene 40, the viewers of the sunny scene 70 will not provided with the winter-like background and related queues but, instead, the provided with corresponding products adapted for summer and sunny weather, in other words, shading fixtures, barbeques, pools, fountains, and the like.

By further example, while car 44 of FIG. 2 may be chosen to be that of a particular make, year, and color i.e., Volkswagen Beatle, 2005 flash-green, a favorite among females, the car of FIG. 3, may be illustrated in the commercial as a Corvette, or a Jeep, or another type of an automobile favorite among men. Thus, while the sense 40 and 70 may be adapted to promote a product (not necessarily related to the shown cars), nevertheless, each of the aforementioned scenes can appeal in a varied manner, respectively, to men and women. In other aspects, the two houses 42 of the scenes 40 and 70 can be shown such that their overall design and shape varies in accordance with different population groups. For example, the house of FIG. 2 can be personalized to have Victorian-type architecture, such as that appealable to certain conservative or old fashion population segments. By contrast, the house shown in the scene 70 may be personalized to have a modem type architecture, thereby appealing to younger population groups.

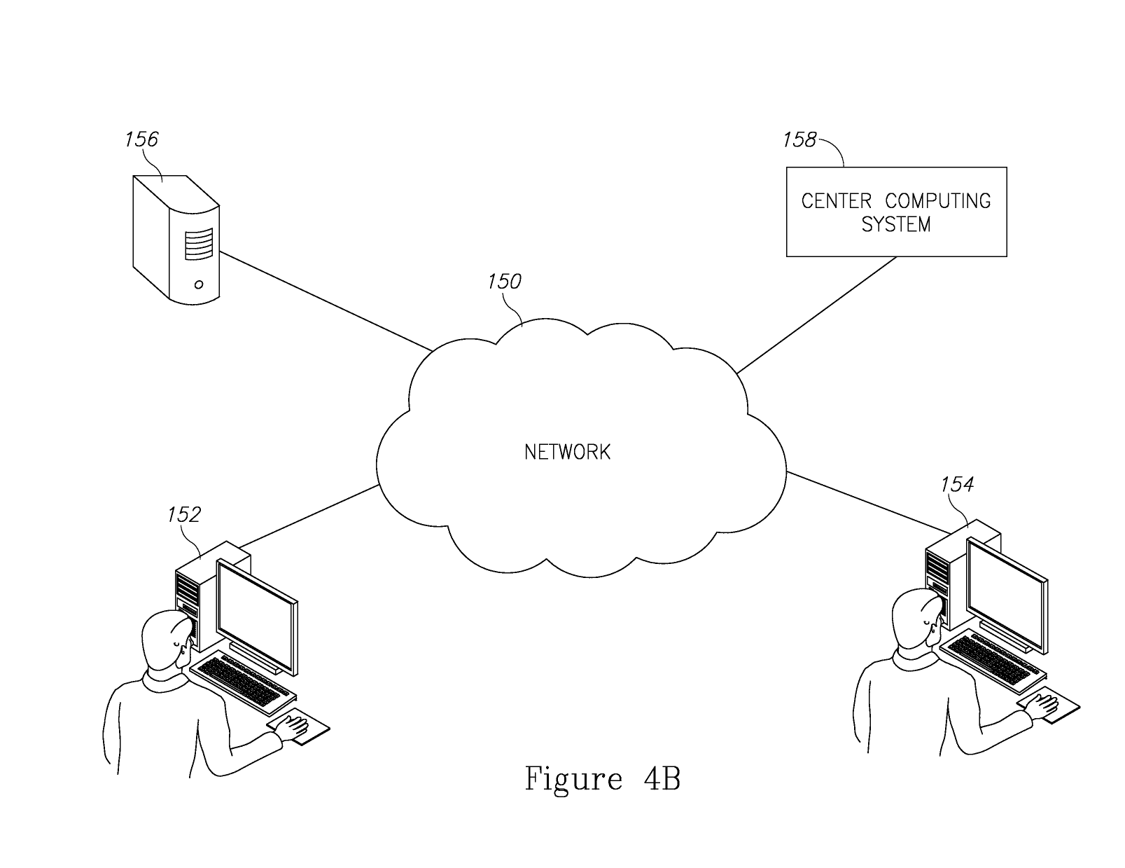

FIG. 4A is a block diagram of a system 100 for providing personalized video over a network, in accordance with an embodiment of the present technique. Generally, the system 100 may be considered as a central computing system such as one forming a portion of a communications network, or computing cluster, a cloud computing structure, or a combination thereof. Accordingly the system 100 is adapted to connect various nodes, such as servers, computer systems and end users, as well as for facilitating the transfer of data between nodes/end users. Further, the system 100 may be part of and/or reside in an Internet Network, an Intranet, or other types of local, wide and/ or global area communications network, such as those formed of a wire line network, wireless network, satellite network, or a combination thereof.

As further illustrated, the system 100 includes a feed generator device 110, a software plug-in device 112, a rendering engine device 114, and ad server device 116. Those skilled in the will appreciate that the term device, as used herein, may encompass one, multiple, and/or an ensemble of devices, formed either as stand alone or a combination of hardware and/or software platforms, each adapted to store and/or execute various algorithms, routines, and various computational tasks for manipulating and configuring digital elements/templates (e.g., FIG. 1) to ultimately generate personalized digital videos over the Internet or other networks, as described above by FIGS. 2 and 3.

Accordingly, those skilled in the art will appreciate that the system 100 and the devices 110-116 may include, either alone or in combination, various microprocessors, servers, such as those available, for example, by Sun Microsystems, Hewlett Packard, Dell, International Business Machines (IBM), and/or other known processor and server vendors and providers. In addition, the devices 110-116 may include, either alone or in combination, hardware devices, memory and storage devices, graphic cards, routers, wireless devices and other modules for receiving, transmitting and/or processing data.

In addition, the system 100, particularly, the devices 110-116 may be housed and/or run on a computing cloud, such as that available by Amazon.com and/or similar cloud-providing vendors. As such, the system 100 and its various components may be adapted to run various software platforms and packages, such as those providing code written in Java, Python, Ruby on Rails, and/or other computer languages, for facilitating the everyday operation and use of the system 100.

In accordance with one embodiment of the present technique, the feed generator 110 may form, for example, an RSS feed generator, adapted to intake information, such as a website URL, and or other related material included as part of a specific website 118 belonging to particular vendor(s). Such vendors having the website 118 may include firm(s), commercial companies, or any private or public organization interested in providing the general public with information and content regarding its various products, services, as well as any other general and/or specific information adapted to promote or otherwise enhance the company's image in the public eye. As will be discussed below, such information may include digital content in a form of a digital movie, such as one that can be downloaded and played by an average home or office user upon throughout a communication session, as may happen when a user generally browses the Internet.

Further, once the system 100 obtains a desired website and URL information via the generator 110, (that is, from where the URL information is stored) the software plugging device 112 obtains original ads 120 to further process such ads and provide personalized digital video ads adapted to appeal to specific segments, groups, locations, genders and so forth. As mentioned, such movies may include advertizing and other promotional material, as promulgated by the vendor of the website 118. Further, the device 112, particularly, software plug-ins employed therein are adapted to generally analyze digital items form which the digital movie is formed. In so doing, the device 112 finds and determines the position of dynamic elements, elements 16-20 (see FIG. 1) so as that those can be modified and/or edited in accordance. Hence, an animator employing the plug-in device 112 can define and mange dynamic texts, visual animations, images, and voice to fit a specific ad that can be personalized and adapted for specific users segment located therein.

More specifically, the device 112 utilizes the non-dynamical elements in conjunction with dynamical elements of the ad, i.e., movie, whereby dummy texts may be inserted to the ad, via an editing software, ultimately determined by constraints are configured in accordance with a desired implementation. For example, certain portions of the movie including text messages may be designated for dynamic rendering, eventually determined according to the animator's choice and/or according to specified demands. By further example, the device 112 can be used to insert and configure certain desired images, as well as vary the properties of images existing in an otherwise distributed movie. This may also include designating and configuring dynamic image background features, such opacity, brightness, lighting, object views, text images and other related visual features.

These and other operations, as performed by the device 112, create what may be called a master ad that can be provided to core rendering engine device 114, adapted to compose all variations of the video ads in accordance with the specified regional and/or other types of preferences to where the ad is intended. In so doing, the rendering engine 114 receives personalized parameters 122 which determine the uniqueness of each ad, as well as the extent to which dynamic elements within each video are varied. Accordingly, the engine 114 inserts into the master ad provided by the software plug-ins 112 actual specific data values to create actual videos, where each video is uniquely created to reflect the various changes in an otherwise original ad, modified to create multiple ads that are each adapted to target a certain region, population and so forth.

Once the rendering engine 114 creates the multiple ad movies, the engine 114 encodes each of the multiple movies according to certain accepted and usable image formats, such as .JPEG, .GIF, .MPEG, and other image and/or video well known and used in the industry. Such encoded files are, thereafter, provided to targeting server 116 adapted to receive request for the videos from multiple locations or with users segmentation parameters. Accordingly, upon such requests, the server 116 outputs personalized video ads to multiple end users 124, 126 and 128, including home, office, or other users having access to websites, such as the website 118. In this manner, each of the different users 124, 126 and 128 may individually receive a personalized video that accommodates and is made to fit the user's regional or geographical location and setting. Thus, while outputs 124-128 may generally be formed of the same ad (see FIGS. 2 and 3), each sharing similar content information and appearance, those outputs may differ to some extent according to the personalized preferences 122, defined above. For example, users viewing output 124 in one region may view a video that may be visually identical the output 126 viewed in another region, however, the video 124 may contain textual information (e.g., maps, location address, store names, etc.) indicative of the first region while the output 126 may contain textual information indicative of the second region, yet, different from the first region. As mentioned herein, the varied outs 124-126 may contain personalized attributes appealable to various user groups, such as gender, groups, demographic groups, cultural groups, age groups, employment groups, social groups, artistic and academic groups, fraternities, hobby and sport clubs, and/or other associations with which general users having access to the network can relate. Thus, personalized videos discusses herein can provide an otherwise generic advertisement while tweaking certain images, colors, sceneries, and/or voices, i.e., dialects, languages and the like to appeal to certain group segments who may find those particular colors and/or accent appealing. In so doing, the present technique creates a multitude of versions of the same ad, each having its own personalized features for targeting a certain population group, while preserving the overall content conveyed by the originally and previously created and distributed ad.

FIG. 4B illustrates a network for providing utilizing personalized videos, in accordance with an exemplary embodiment of the present technique. Accordingly, the figure depicts a communications network 150 adapted for connecting various nodes, such as servers, computer systems and end users, as well as for facilitating the transfer of data between the nodes and end users. The network 150 is adapted for processing, forming, and distributing personalized videos by those systems described above, i.e., system 100 and its various inputs and outputs.

More specifically, FIG. 4B illustrates, nodes/endpoints/end users 152 and 154, as well as, servers 156, and central computing system (CCS) 158. The user 152 and/or 154 may be client computers such as a home or office personal computer (PC), a remote client, a thin client or other type of computer and/or processing interface adapted for general data processing and for connecting to the network 150. Although not illustrated by FIG. 4B, the client computers may further be coupled and/or connected to other peripheral devices, such as monitors, keyboards, mice, printers, routers, wireless devices, microphones, speakers, cameras, finger print identifiers, external memory devices, and other devices. The PC 152 may include software platforms and operating systems, such Windows, Linux-Red Hat, and other supporting programs. Hence, the users 152 and 154 may be provided with personalized videos in accordance with the above outputs 124-128, depicting personalized videos to each of the users 152 and 154 outputs, respectively. Thus, in accordance with each of the user's (152 and 154) general preferences and desires, the outputs 124-128 may include video having features personalized to a variety of users over the network 150.

Further, the server 156 and CCS 158 may be adapted for storing, routing and/or communicating data within the network 150 and/or other networks to which the server 156 and CCS may be connected. Thus, the server 156 may store information related to material included as part of vendor website, such as those belonging to vendor(s) 118, and/or the server 156 may store the original ads 120 and/or the obtained parameters specifying the manner by which personalized should be rendered. In addition, the CCS 158 may be formed of multiple processors, servers, and/or other dedicated devices, such as those used for forming, processing, and/or encoding personalized videos, as implemented by the system 100 illustrated and discussed above.

Further, in an exemplary embodiment, the server 156 may be of the type available by Sun Microsystems, Hewlett Packard, Dell, International Business Machines (IBM), and/or other known server vendors and providers. Accordingly, the server 156 and the CCS 158 may include various hardware devices, such as microprocessors, memory cards, graphic cards, routers, wireless devices and other modules for receiving, transmitting and/or processing data. In addition, the servers may include various software platforms and packages, such as those providing code written in Java, Python, Ruby on Rails, and/or other computer languages, for facilitating the everyday operation and use of the server 14 and CCS 158 as part of the network 150. It should further be borne in mind that the user nodes 152 and 154 and the servers 156 and CCS 156 are exemplary, and that the network 150 may include many other additional user nodes similar to the users 152 and 154, as well as, multiple other servers similar to those discussed herein.

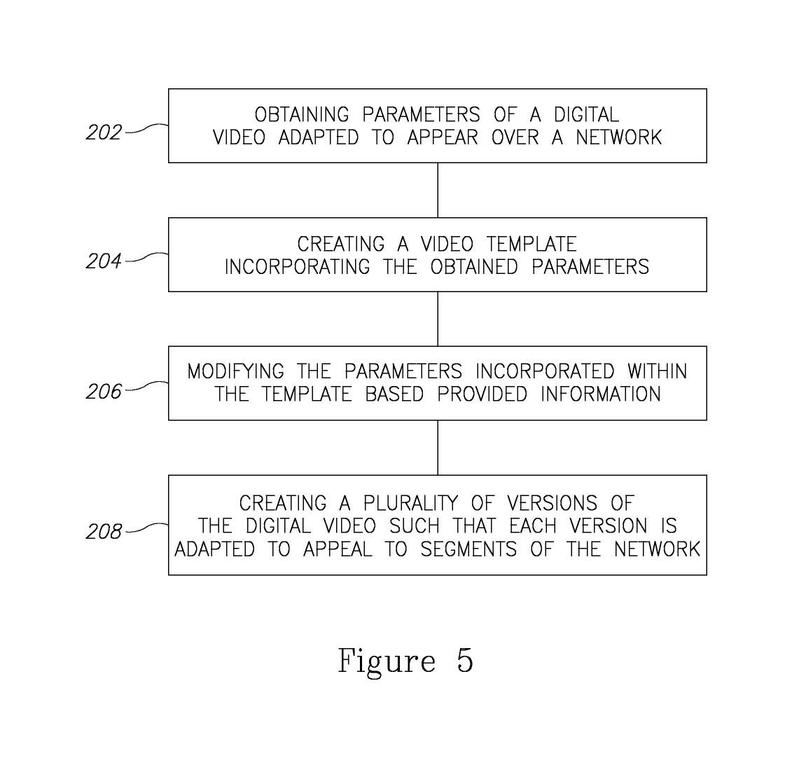

FIG. 5 is a block diagram describing a process, in accordance with an embodiment of the present technique. Accordingly, a process 200 is disclosed whereby digital videos generally representing ads and commercials to users of the Internet are custom made and personalized according to predefined information, much of which pertains to the actually receiving and viewing the digital ad. Thus, process 200 employs various hardware and/or software platforms for executing certain routines, algorithms and/or programs adapted obtain, modify and ultimately encode the personalized digital ads, as described above with regard to the foregoing figures. Hence, those skilled will appreciate the such computerized implementations and software may be designed, encoded and/or compiled using a variety of tools including using an assortment of computer codes and languages, including C, C++, Python, Pearl, Ruby on Rails, and/or other languages, as would be appreciated by one having ordinary skill.

More specifically, in utilizing the abovementioned means, the process 200 includes step 202 whereby the process 200 obtains parameters of a digital video. Such parameters may relate to the digital elements forming the video, including static and dynamic elements that ultimately are included within the video and that manifest to the viewer as images, voices and/or other viewable, as well as, audible sceneries, queues, recordings and so forth accessible to the user while viewing such videos of a network, i.e., the Internet.

Accordingly, at step 204 of process 200, the above obtained video parameters are used to create a video template for incorporating the obtained parameters so that those parameters may be further manipulated and modified to accommodate certain requirements and information pertaining to the user. Accordingly, based on the information pertaining to the user and the template created at step 204, at step 206 the process 200 modifies the video parameters to create multiple versions of the digital video. Hence, by the process 200 each one of the versions of the video ads is designated for specific users, such as those located at different regions where the video can be accessed and viewed. In this manner, the present technique provides personalized versions of the same ad, whereby each ad is tailored to fit to certain settings, preferences, locations, social habits, weather conditions and/or other attributes to which users can better relate and/or associate with.

What is claimed is:

1. A method, comprising:
obtaining through one and/or more feed generators parameters of a digital video, wherein the video is adapted to be provided to users of a network;
modifying by one and/or more software generators one or more of the obtained parameters, wherein the modification is based on information relating to segments of the users of the network;
creating by one and/or more rendering engines, based on the modification, a plurality of versions of the digital video, wherein each one of the plurality of versions comprises a broadcast quality digital video adapted to appeal to at least one of the segments of the users of the network.

2. The method according to claim 1, comprising creating by one and/or more software generators a video template incorporating the obtained parameters, and modifying by the one and/or more rendering engines the template to create the plurality of broadcast quality versions of the digital video.

3. The method according to claim 1, wherein digital video comprises a commercial video appearing over an Internet webpage.

4. The method according to claim 1, wherein the parameters comprise, text data, visual data, image data, audible data, voice data, animation data, look and feel data or any combination thereof.

5. The method according to claim 1, wherein the information comprises at least one of location data, language data, weather data, marketing data, financial data, demographics data, social information data, consumer data, local data, and/or any combination thereof.

6. The method according to claim 1, comprising encoding each one of the plurality of versions of the digital videos.

7. The method according to claim 1, wherein obtaining comprises utilizing a Really Simple Syndication (RSS) feed generators to obtain the parameters of the digital video.

8. The method according to claim 5, wherein segments of the users comprise gender groups, demographic groups, age groups, employment groups, cultural groups, academic groups, sport groups, hobby groups, social groups and/or any combination thereof.

9. A system for generating broadcast quality digital videos, comprising:
a feed generator adapted to obtain parameters of a digital video, wherein the video is adapted to be provided to users of a network;
at least one processor coupled to the feed generator, wherein the at least one processor is adapted to modify one or more of the obtained parameters, wherein the modification is based on information relating to segments of the users of the network, and wherein the at least one processor is adapted to create, based on the modification, a plurality of versions of the digital video, wherein each one of the plurality of versions comprises a digital video adapted to appeal to at least one of the segments of the users of the network.

10. The system according to claim 9, wherein the at least one processor is adapted to create a video template incorporating the obtained parameters, and wherein the one or more processors is adapted to modify the template to create the plurality of versions of the digital video.

11. The system according to claim 9, wherein digital video comprises a commercial video appearing over an Internet webpage.

12. The system according to claim 9, wherein the parameters comprise, text data, visual data, image data, audible data, voice data, animation data, touch and feel data or any combination thereof.

13. The system according to claim 9, wherein the information comprises at least one of location data, language data, weather data, marketing data, financial data, demographics data, social information data, consumer data, local data, and/or any combination thereof.

14. The system according to claim 9, comprising an encoder coupled to the plurality processors, wherein the adaptor is adapted to encode each one of the plurality of versions of the digital videos.

15. The system according to claim 9, wherein the feed generator comprises a Really Simple Syndication (RSS) feed generators to obtain the parameters of the digital video.

16. The system according to claim 9, wherein segments of the users comprise gender groups, demographic groups, age groups, employment groups, cultural groups, academic groups, sport groups, hobby groups, social groups and/or any combination thereof.

17. A computer program product comprising:
a computer readable storage medium having computer readable program embodied therewith, the computer readable program comprising:
computer readable program configured to obtain parameters of a digital video, wherein the video is adapted to be provided to users of a network;
computer readable medium configured to modify the obtained parameters, wherein the modification is based on information relating to segments of the users of the network; and
computer readable medium configured to create a plurality of versions of the digital video, wherein each one of the plurality of versions comprises a digital video adapted to appeal to at least one of the segments of the users of the network.

18. The computer program product according to claim 17, comprising computer readable program configured to create a video template incorporating the obtained parameters, and a computer readable program adapted to modify by the one and/or more rendering engines the template to create the plurality of versions of the digital video.

19. The computer program product according to claim 17, wherein digital video comprises a commercial video appearing over an Internet webpage.

20. The computer program product according to claim 17, wherein the parameters comprise, text data, visual data, image data, audible data, voice data, animation data, look and feel data, or any combination thereof.

21. The computer program product according to claim 17, wherein the provided information comprises at least one of location data, language data, weather data, marketing data, financial data, demographics data, social information data, consumer data, local data, and/or any combination thereof.

22. The computer program product according to claim 17, a computer readable program configured to encode each one of the plurality of versions of the digital videos.

23. The computer program product according to claim 17, wherein segments of the users comprise gender groups, demographic groups, age groups, employment groups, cultural groups, academic groups, sport groups, hobby groups, social groups and/or any combination thereof.
